(19) United States
(12) Patent Application Publication
(10) Pub. No.: US 2003/0115554 A1
(43) Pub. Date: Jun. 19, 2003

(54) Storage medium for recording interface specification definition

(75) Inventors: Koji Ara, Kodaira (JP); Kei Suzuki, Kokubunji (JP); Tsuneo Nakata, Saitama (JP); Hiroaki Iwashita, Yokohama (JP); Satoshi Kowatari, Kawasaki (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 10/295,839

(22) Filed: Nov. 18, 2002

(30) Foreign Application Priority Data
Dec. 18, 2001 (JP) 2001-384506

(51) Int. Cl. G06F 17/50

(52) U.S. Cl. 716/1

(57) ABSTRACT

Information of definitions on interface specifications capable of expressing parallel behaviors is stored in a computer-readable storage medium while amounts of information are reduced. The present invention comprises: a first identifier region for storing, as a first set of ports, combination patterns of signal values that respective ports of a first set of ports are capable of assuming; a second identifier region for storing, as a second set of ports, combination patterns of signal values that respective ports of a second set of ports are capable of assuming; and a third identifier region for storing, as a third set of ports, functions of a circuit module defined as combinations of first identifiers and second identifiers, wherein the third identifiers include codes (par) indicating that starting order of combination patterns corresponding to the first identifiers and combination patterns corresponding to the second identifiers are undefined.

### BACKGROUND OF THE INVENTION

The present invention relates to an integrated circuit or digital system configured by connecting a plurality of circuit modules, and particularly to a technique for correctly defining specifications of the interfaces of the circuit modules and using this to simplify each connection between the circuit modules. The present invention further relates to a technique for making designs of LSIs by using such technique.

Improvement in the degrees of integration of LSIs has made it possible to mount the most of elements required for configuring a system, on a single semiconductor chip. In the case of designing such a large scaled system LSI, it will be possible to reduce costs and man-month of the designing by designing in combination with circuit modules having been already designed and owned as properties or with circuit modules having been purchased elsewhere. To enable reuse of the circuit modules having been already designed, expressing respective functions of the circuit modules in linkage with signal values and their chronological orders that respective input/output ports are capable of assuming at a specific time has been disclosed in “OwL: An Interface Description Language for IP Reuse” (Custom Integrated Circuit Conference, 1999, pp. 403-406) by Kei Suzuki et al., who is the inventors of the present invention. According to this disclosure, it is stated that understanding specifications of the circuit modules, that is, specifications of the circuit modules obtained from a computer after functions and behaviors explained through timing charts or the like are expressed on the computer by using a state machine is supported. It is further stated that verification for the connection between to connect given two circuit modules and automation of the designing such as the synthesizing or the like are performed. It is noted that there is a reference of Japanese Patent Laid-open No. 2000-123064 as an application relating to the contents disclosed in the above-mentioned document. Japanese Patent Laid-open No. 2001-297124 further discloses the invention of dividing external ports of circuit modules into a plurality of sets of ports and of employing a certain set of ports as a reference to enable designation of timings in signal changes of other sets of ports.

### SUMMARY OF THE INVENTION

However, in conventionally suggested methods for expressing module specifications, in the case of trying to describe actually present signal changes, there have been signal changes incapable of description and signal changes having any fears for being substantially incapable of description because the amounts of description become huge.

1. Parallel Behaviors without Constraining Order Dependence

There is a plurality of sets of ports. Conventional methods for expressing module specifications could not express signal changes in which starting orders and terminating orders of sub-transactions in these sets of ports are uniquely determined. For example, some interface circuits for communication systems are such that identical data are transmitted using a plurality of sets of ports for the purpose of reinforcing resistance against communication noises and such that correct data are reproduced on the basis of data received by the plurality of set of ports. It is therefore necessary to permit shifts in timings of arrival of received data owing to physical delays and changes in apparent lengths of data.

For example, possible starting orders of sub-transactions in the presence of three sets of ports, A, B and C, in the receiving side is ABC, ACB, BAC, BCA, CAB and CBA. However, the conventional methods for expressing module expressions have been assumed only to employ any one set of ports as a reference and determine orders of the remaining sets of orders, so that signal changes in which none of the sets of ports becoming a reference could not be defined.

It is noted that, in the present descriptions, the term “transaction” indicates a series of behaviors (signal changes) for executing a single function and the term “sub-transaction” indicates an individual behavior (signal change) that is executed during the transaction.

2. Parallel Behaviors Sharing Responses

Signal changes, in which one single change corresponds to a plurality of transactions, could not be expressed in the conventional methods for expressing module specifications. For example, suppose that there is an interface having a master module and a slave module connected to each other, wherein a transaction (write) occurs in the master module and a request packet is sent to the slave module (sub-transaction: transfer of write request) and the slave module returns a response packet in the case of correctly receiving the data (sub-transaction: return of response). The master module successively issues requests for transaction without awaiting a response from the slave module, and there are some cases where the slave module is permitted to return a single response when the process thereof has been correctly executed in response to a plurality of requests. This is permitted to avoid congestion of buses that are caused by strictly associating requests and responses. For example, when the master module issued three requests without awaiting any response from the slave module and a single response indicating that data have been correctly received was returned thereafter from the slave module, this is to indicate that all of the three data have been correctly received. The conventional methods have been assumed for transactions to comprise respective individual sub-transactions, so that it was impossible to express a specification in which a single sub-transaction has been shared by a plurality of transactions.

3. Split Transactions

Split transactions are signal changes in which a plurality of sub-transactions of a certain transaction occurs at arbitrary temporal intervals within the same set of ports and in which sub-tractions of the other transactions occur in the meantime thereof. For example, interfaces correspond to this, the interfaces having interactive data signal lines with request packets and response packets intercommunicated at mutual temporal intervals. The conventional methods for expressing module specifications have not been assumed for such sub-transactions to occur on an identical set of ports.

4. Sub-transactions Occurring in Random Order

There are signal changes in which some sub-transactions occur in random order when a transaction T is executed. For example, suppose that a single master module is connected to three slave modules A, B and C through a bus. When the master module issues a request, all of the slave modules respond to the request and each of them sends data to the master (this is referred to as “broadcasting”). Since responses are sent from the slave modules in ready order, the order for sending the responses is six patterns. It was necessary to enumerate the order in the conventional methods for expressing module specifications. The description is as follows, for example.

TRANSACTION T=

REQ

[RES_A RES_B RES_C

|RES_A RES_C RES_B

|RES_B RES_A RES_C

|RES_B RES_C RES_A

|RES_C RES_A RES_B

|RES_C RES_B RES_A]

Here, the bracket [ ] indicates that only one of the portions partitioned therein through vertical bars | occurs. It is represented that the transaction T comprises a request “REQ” and responses “RES” from the slave modules A, B and C, and that the order of the responses “RES” is six patterns. In this manner, the number of combinations increases on a factorial basis, so that it is necessary to enumerate twenty-four patterns in the presence of four slave modules and one hundred-twenty patterns in the presence of five thereof. Therefore, it was in fact impossible to express them.

5. Common Constraints of Transactions

A plurality of transactions, which a circuit module has, may include common constraints. For example, suppose that a circuit module is capable of executing ten types of transactions, wherein all transactions have the common constraint of the fact that “a response must return within ten cycles after issuing a request for transaction”. Since signal changes are defined in units of respective transactions in the conventional methods for expressing module specifications, constraints must be written for all of the transactions. This is as follows, for example.

TRANSACTION READ_BYTE=REQ IDLE* ′NUMIDLE DATA

TRANSACTION READ_WORD=REQ IDLE* ′NUMIDLE DATA

TRANSACTION READ_LONG=REQ IDLE* ′NUMIDLE DATA

TRANSACTION WRITE_BYTE=REQ IDLE* ′NUMIDLE DATA

TRANSACTION WRITE_BYTE=REQ IDLE* ′NUMIDLE DATA

TRANSACTION WRITE_BYTE=REQ IDLE* ′NUMIDLE DATA

PROPERTY NUMIDLE:(#IDLE<=9)

The code, *, is a code indicating that the state immediately before * is to be repeated for 0 time or more, and the code, ′, is a code indicating that a constraint is to be described thereafter. Further, the term, “PROPERTY”, is a constraint present at the time of transition of a state machine and it is limited by the constraint “NUMIDLE” that “IDLE” is repeated for nine times or less.

Therefore, the amount of description of a constraint is proportional to a product of the number of constraints and the number of transactions. It is not uncommon in an actual circuit that one transaction has several to over ten constraints. This made it difficult to actually describe interfaces.

In such constraints are enumerated the number of data to be read, time intervals between previous data and following data, time intervals from previous transactions to following transactions, the maximum number permitted for consecutively executing transactions, and the like, besides the minimum cycle number and the maximum cycle number of requests.

6. Common Procedures of Transactions

A plurality of transactions that a circuit module has may include common procedures. In the present specification, the term “procedure” represents behaviors that are collaterally performed during the execution of sub-transactions. While the sub-transactions are behaviors that are made in an intercommunicating manner between circuit modules, the procedures are generally behaviors that are individually performed by the respective circuit modules. More particularly, such procedures are behaviors for setting flags in executing the transactions, counting the number of occurrences of events, or measuring time intervals from one event to another event. Procedures have been referred to within the definitions of transactions in the conventional methods for expressing module specifications. Accordingly, the amount of descriptions has increased in proportion to a product of the number of procedures and the number of transactions. This is as follows, for example.

TRANSACTION READ_BYTE=REQ (IDLE $COUNTIDLE)* DATA

TRANSACTION READ_WORD=REQ (IDLE $COUNTIDLE)* DATA

TRANSACTION READ_LONG=REQ (IDLE $COUNTIDLE)* DATA

TRANSACTION WRITE_BYTE=REQ (IDLE $COUNTIDLE)* DATA

TRANSACTION WRITE_BYTE=REQ (IDLE $COUNTIDLE)* DATA

TRANSACTION WRITE_BYTE=REQ (IDLE $COUNTIDLE)* DATA

TASK COUNTIDLE:{N=N+1;}

The code, $, is a code indicating that a name of a procedure will be described thereafter. “TASK” defines procedures and count repetitions of “IDLE” by the procedure “COUNTIDLE”.

7. Order Definition of Transactions

A period of time of a state in which nothing occurs may be generated during the execution of a plurality of transactions. The state in which no transactions are being performed has been also defined explicitly as a single state in the conventional methods for expressing module specifications, and it has been required to explicitly describe under what kind of conditions such states may occur by using regular expressions. For example, while read (READ) or write (WRITE) is performed after initialization (INIT), interfaces arbitrarily having start timings of the transactions following the initialization have defined non-executing states “IDLE” and had to be expressed as follows.

INIT [READ|WRITE|IDLE]+

The code, +, is a code representing that the state immediately before + is repeated by once or more. In this manner, the non-executing states are defined similarly to ordinary transactions. Therefore, it will be impossible, for people other than people having made the descriptions, to know, depending on the naming, which is representative of transactions and which is of non-executing states. Further, when the intentions of designers are considered, it will be impossible to read, from the descriptions, information of which portions a sequence is initialized up to and also information of which portions the sequence represents a stationary state from. Additionally, there also arises a problem of increase in the amount of descriptions because the descriptions must be each time inserted into all portions that can become non-executing states.

In this manner, the conventional methods for expressing module specifications have not been capable of fully and briefly expressing the specifications of actually present circuit modules.

For solving the above-mentioned problem, specified codes are defined to store interface actions that are executed in a parallel manner.

In the case of no constraints of order dependence, a computer-readable storage medium for recording interface information of a circuit module having a first set of ports and a second set of ports, comprises: a first identifier region for storing, as a first set of identifiers, combination patterns of signal values that respective ports of the first set of ports are capable of assuming at a specific time; a second identifier region for storing, as a second set of identifiers, combination patterns of signal values that respective ports of the second set of ports are capable of assuming at a specific time; and a third identifier region for storing, as a third set of identifiers, functions of the circuit modules defined as combinations of specified first identifiers stored in the first identifier region and specified second identifiers stored in the second identifier region, wherein a third identifiers include a string of codes indicating that starting order of the specified first identifiers, and respective combination patterns corresponding to the specified second identifiers and the specified first identifiers, and combination patterns corresponding to the second identifiers is undefined.

In the case of sharing responses, the third identifiers include a string of codes indicating that the combination patterns corresponding to the specified second identifiers occur once according as the specified first identifiers and respective combination patterns corresponding to the specified second identifiers and the specified first identifiers occur twice or more.

Split transactions comprises: a first identifier region for storing, as a set of identifiers, combination patterns of signal values that respective ports of a set of ports are capable of assuming at a specific time; and a second identifier region for storing, as a second set of identifiers, functions of a circuit module defined as combinations of a plurality of first identifiers stored in the first identifier region, wherein the second identifiers include a string of codes indicating that the plurality of first identifiers and a plurality of combination patterns corresponding to the plurality of first identifiers occur at a temporal interval, and that combination patterns corresponding to other identifiers stored in the first identifier region are capable of occurring meantime.

Further, concerning sub-transactions occurring in random order, the second identifiers include a string of codes indicating that a plurality of first identifiers and a plurality of combination patterns corresponding to the plurality of first identifiers are capable of occurring in arbitrary order.

Further, concerning constraints and procedures, it is possible to define constraints and procedures common to a plurality of transactions.

Further, meaningful behaviors (transactions) and meaningless behaviors (non-executing states) are stored in an at least discriminated manner. Also, behaviors belonging to an initialization sequence are separated from meaningful behaviors and are stored.

### BRIEF DESCRIPTION OF THE DRAWINGS

FIG. 1 is a view for explaining a first configurative example of a first embodiment.

FIG. 2 is a view illustrating a data structure for an interface description corresponding to FIG. 1.

FIG. 3 is a view for explaining a second configurative example of a first embodiment.

FIG. 4 is a view illustrating a data structure for an interface description corresponding to FIG. 3.

FIG. 5 is a view for explaining a third configurative example of a first embodiment.

FIG. 6 is a view illustrating a data structure for an interface description corresponding to FIG. 5.

FIG. 7 is a view for explaining a fourth configurative example of a first embodiment.

FIG. 8 is a view illustrating a data structure for an interface description corresponding to FIG. 7.

FIG. 9 is a view illustrating a data structure for an interface description corresponding to a fifth configurative example of a first embodiment.

FIG. 10 is a view illustrating a data structure for an interface description corresponding to a sixth configurative example of a first embodiment.

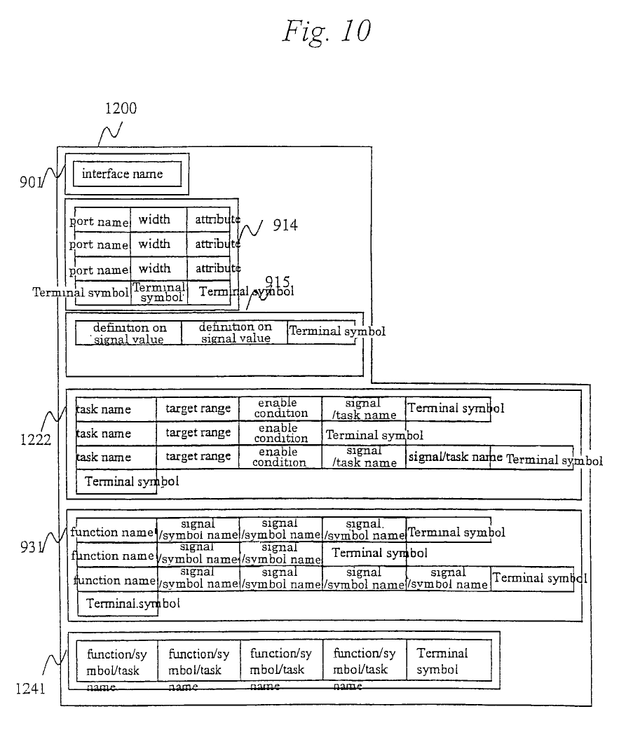

FIG. 11 is a view illustrating a data structure for an interface description corresponding to a seventh configurative example of a first embodiment.

FIG. 12 is a view illustrating a flow for generating a dummy circuit for verification in a second embodiment.

FIG. 13 is a view illustrating a computer system for executing a simulation in a second embodiment.

### DESCRIPTION OF THE PREFERRED EMBODIMENTS

### First Embodiment

An embodiments of the present invention will be described below with reference to the drawings.

1. Parallel Behaviors with No Constraints of Order Dependence

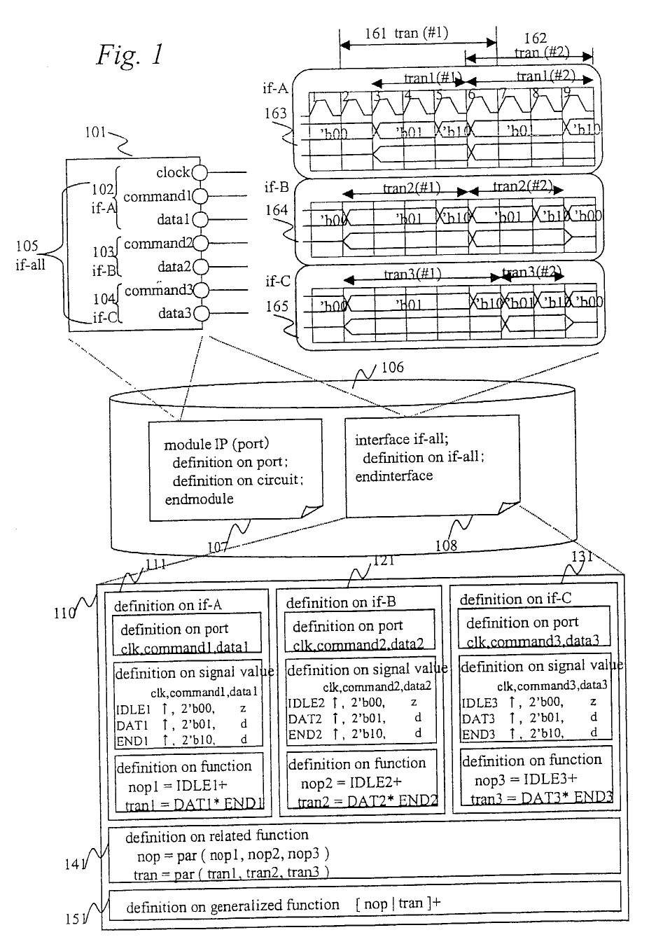

FIG. 1 is a view for explaining a circuit module equipped with an interface having parallel behaviors with no constraints of order dependence.

A logic circuit 101 includes ports 105. The ports 105 are divided into a set of ports 102, a set of ports 103, and a set of ports 104, each of which constitutes a meaningful unity. Signal waveforms corresponding to the sets of ports 102 to 104 are respectively illustrated as input/output sequences 163 to 165.

Structures or behaviors of the logic circuit 101 are described by using hardware-described language. This includes definition of ports and definition of the circuit. The definition of the circuit may be one of behavior level, resister transfer level, and gate level. “HDL” data 107 of the above-mentioned logic circuit are stored in a computer readable storage medium 106. Although not particularly limited, the storage medium 106 may be a semiconductor memory, or a magnetic storage medium such as a flexible disk or a hard disk, or an optical storage medium such as a CD-ROM or a DVD. As a pair with the “HDL” data 107, the storage medium 106 stores therein an interface-defined description 108. The interface-defined data 108 are for describing the input/output sequences 163 to 165.

The logic circuit 101 includes a transaction “tran” for receiving data from a connecting side. The connecting side sends the same commands and data to the sets of ports 102, 103 and 104 relative to the logic circuit 101. The logic circuit 101 compares the data received by the respective sets of ports, and performs correction if any errors are present, and receives the correct data. The contents of data received by the sets of ports 102, 103 and 104 are identical. However, lengths of data received by the respective sets of ports and timings at which the data reach the respective sets of ports differ each time depending on respective delays in transmission paths and can thus not be uniquely determined. In the present embodiment, such an interface is expressed by the following format. It is a particular feature thereof that information of definitions on related functions 141 is provided. Such information of definitions on related functions are one type of information of definitions on functions and are information of defining functions that are defined through functions defined in sub-interfaces.

An interface “if-all” includes three sub-interfaces “if-A to -C” respectively corresponding to the sets of ports 102 to 104. Each of the sub-interfaces includes definitions on ports, definitions on signal values, and definitions on functions. The signal values define states that the respective sub-interfaces can assume. In the example of FIG. 1, the interface “if-A” illustrates a state in which, during the rising of a clock signal, a signal that is input to port “data 1” is in a high impedance state when a two-bit signal that is input to port “command 1” at a rising edge on a clock signal is “2′b00”. This state is defined to be “IDLE 1” (example of definition on signal value). A signal value sequence, in which signal value “DAT 1” is repeated 0 time or more and signal value “END 1” occurs once, is defined to be receiving function “tran 1” (example of definition on function). In the interface “if-all”, transactions “tran 1”, “tran 2” and “tran 3” occur without being in order predetermined in advance. Such occurrence of transactions is defined by the information of definitions on related functions 141 and information of definitions on generalized functions 151, and is stored as interface specifications in the storage medium 106. In the example of FIG. 1, it is indicated that the states (“nop”) of “nop 1” to “nop 3” and the states (“tran”) in which transactions “tran 1” to “tran 3” have occurred occur in random order, and that the state of “nop” or “tran” is repeated once or more as a whole of the interface.

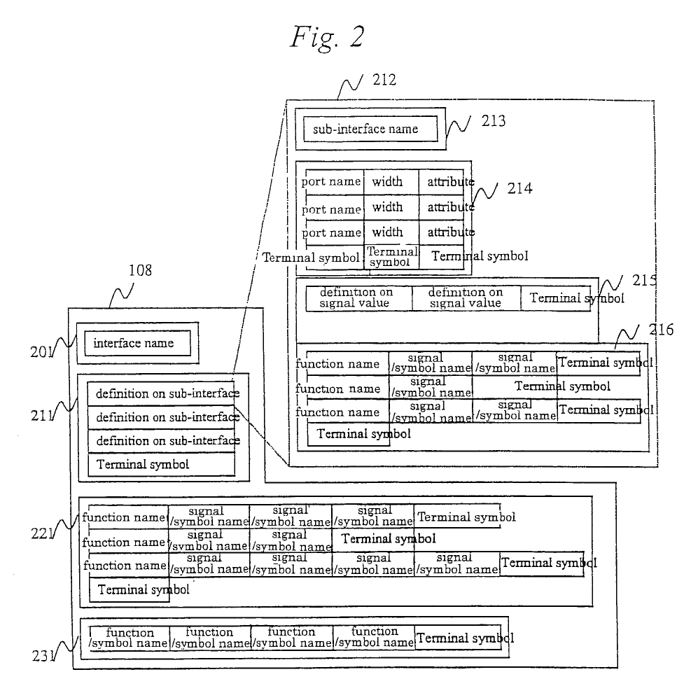

FIG. 2 is a view for explaining a data structure of the data, in the definitions on interfaces 108 of the storage medium 106. Identifiers, formed as strings of codes representing both of the names for instructing states and functions and the like and of the relations therebetween and the like, are stored in the storage medium.

The name of “if-all” is stored in an interface name 201 in the example of FIG. 1. Since the interface “if-all” includes the sub-interfaces of the interfaces “if-A to -C”, the respective sub-interfaces are defined in the information of definitions on sub-interfaces 211. It is noted that, to the respective information, terminal codes for indicating segmentations thereof are added. Information of definitions on ports 214, information of definitions on signal values 215, and information of definitions on functions 216 are stored for the respective sub-interfaces. These correspond to the information of definitions “if-A to -C” 111, 121 and 131 in FIG. 1. Port names, signal widths and attributes are stored as information of definitions on ports 214. The port names are names for identifying a set of ports belonging to this interface (sub-interfaces). The signal widths make definition of how many bits the signals being input and output to and from the respective ports have. Further, the attributes provide discriminations for indicating whether the signals being input and output to and from the respective ports are input signals, output signals or clock signals. Information for defining the states of signal values at a certain time is stored in the information of definitions on signal values 215. Information for defining states (functions) that interfaces defined as signal value sequences can assume are stored in the information on definitions on functions 216. Definitions on functions are described as strings of signal value names or code names. In the example of FIG. 1, the state of “nop 1” is described by the signal value name of “IDLE 1” and the code name of “+”. The codes employed here are regular expression codes for expressing the relationships between signal values (or functions).

Such regular expression codes include the followings.

*: Repetition of 0 time or more

+: Repetition of once or more

< >: Execution of the signal value or function described in

< > 0 by time or once

{n, m}: Repetition of the signal value or function described in { } by n times or more to m times or less

a|b: Selective execution of “a” signal value (function) or

“b” signal value (function)

Information of definitions on related functions 221 and information of definitions of generalized functions 231 are stored to correspond to the information of definitions on related functions 141 and the information of definitions of generalized functions 151 of FIG. 1. The information of definitions on related functions 221 describes appearance order of functions defined in the information of definitions on sub-interfaces 211 as strings of names of definitions on functions or code names. The codes employed here include codes for expressing parallel behaviors for expressing the sequential relationships between signal values (or functions), in addition to the above-mentioned codes for regular expression signals.

The codes for expressing parallel behaviors include the followings.

&/: start “b” signal value (function) after start of “a” signal value (function)

&: start “b” signal value (function) simultaneously with start of “a” signal value (function)

#/: start “b” signal value (function) after completion of “a” signal value (function)

#: start “b” signal value (function) simultaneously with completion of “a” signal value (function)

In the information of definitions on generalized functions 231, order of the functions defined by the information of definitions on related functions 221 is described as strings of the names of definitions on functions and the code names. Regular expression signals and codes for expressing parallel behaviors are also employed here.

At this time, random order starting codes are stored as one of the code names employed in the information of definitions on related functions 221 and the information of definitions on generalized functions 231 in the present invention. In the present embodiment, “par (a, b)” is introduced as a code for representing parallel behaviors started in random order, and indicates that signal values (functions) “a” and signal values (functions) “b” are started in random order.

By using the storage medium storing therein such codes, it will be possible to express interfaces having been able to be expressed through the conventional methods for expressing module specifications and to interpret them on computers.

2. Parallel Behaviors Sharing Responses

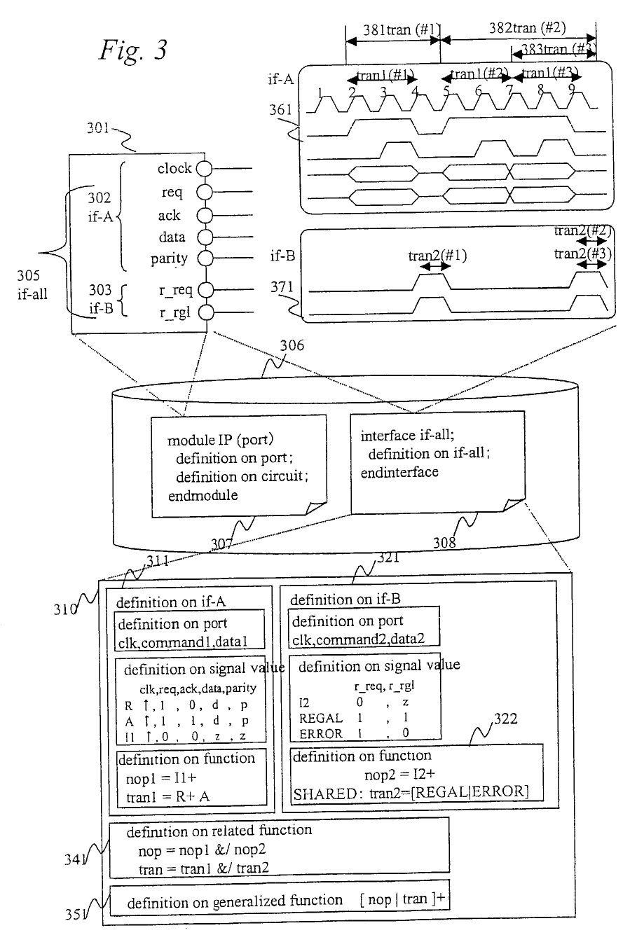

FIG. 3 is a view for explaining a circuit module having an interface with parallel behaviors sharing responses.

A logic circuit 301 includes ports 305. The ports are divided into a set of ports 302 and a set of ports 303, each of which is a meaningful unity. Signal waveforms corresponding to the sets of ports 302 and 303 are respectively illustrated as input/output sequences 361 and 371.

Similarly to FIG. 1, a circuit description 307 of the logic circuit is stored in a storage medium 306 together with data of definitions on interface 308.

The logic circuit 301 can generate transaction of writing. The logic circuit 301 outputs data “data” and parity “parity” simultaneously with a request “req”. A module in the connecting side analyses presence or absence of errors in data by using the sent data and the parities thereof, and returns the results of judgment as responses “r_rgl”. At this time, timing signals “r_req” indicating capture timings also are simultaneously returned therewith. While each result of judgment is basically returned in response to a single writing, results in response to a plurality of writings may be returned through one response. More particularly, a first waveform in an input/output sequence 371 indicates a response to tran1(#1) while a second waveform is a response to both of tran1(#2) and tran1(#3). If the second response is “ERROR” (or “REGAL” in the case of FIG. 3), the logic circuit 301 must retry all writings to a response having not been made until then (that is, “tran2” and “tran3”).

In the present embodiment, information indicating that some signal changes of information of definitions on functions 322 can correspond to a plurality of transactions (wherein the function of “tran2” of “if-B” definition functions applies to this) is stored. By storing such information, it will be possible to interpret the fact that the sub-transaction of “tran2” corresponds to a plurality of transactions “tran”. More particularly, transaction “tran” comprises sub-transactions “tran1” and “tran2” (refer to information of definitions on related functions 341). When “tran2” is constituted to correspond to a plurality of transactions in the information of definitions on functions 322, it is interpreted that the occurrence of “tran2” after “tran1” occurs for a plurality of times will respond to the “tran1” occurring for the plurality of times.

The sharing of responses may include not only the sharing of response with the same transactions but also the sharing of responses with different kinds of transactions. For example, suppose that there are the different transactions of “write_byte” and “write_word”, each of which comprises a write request (sub-transactions “req_byte” and “req_word”) and a sharable response to the results of the write (sub-transaction “res”). In this case, the following information is stored in the storage medium 306.

SHARED: res;

write_byte=req_byte &/res;

write_word=req_word &/res;

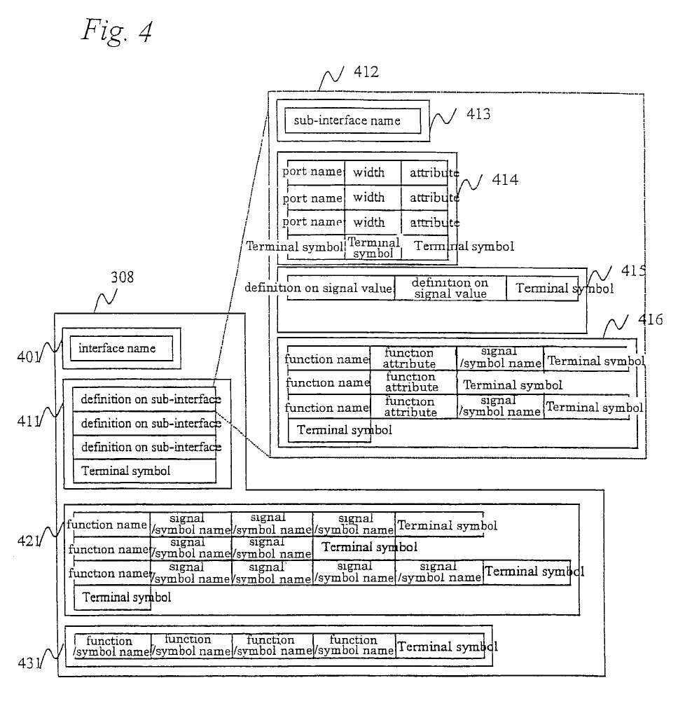

FIG. 4 is a view explaining a data structure in an electronic storage media of the data of definitions on interface 308 which are stored in a computer readable storage medium as explained in FIG. 3.

As a point that differs from FIG. 2, a code “SHARED”, which indicates sharable attributes among a plurality of transactions as a function attribute, is stored in information of definitions on functions 416. By using the storage medium storing therein such information, it will be possible to express an interface having been incapable of being expressed through the methods for expressing module specifications, the methods which have been bases on the conventional state transition machines, and to interpret them on a computer.

3. Split Transactions

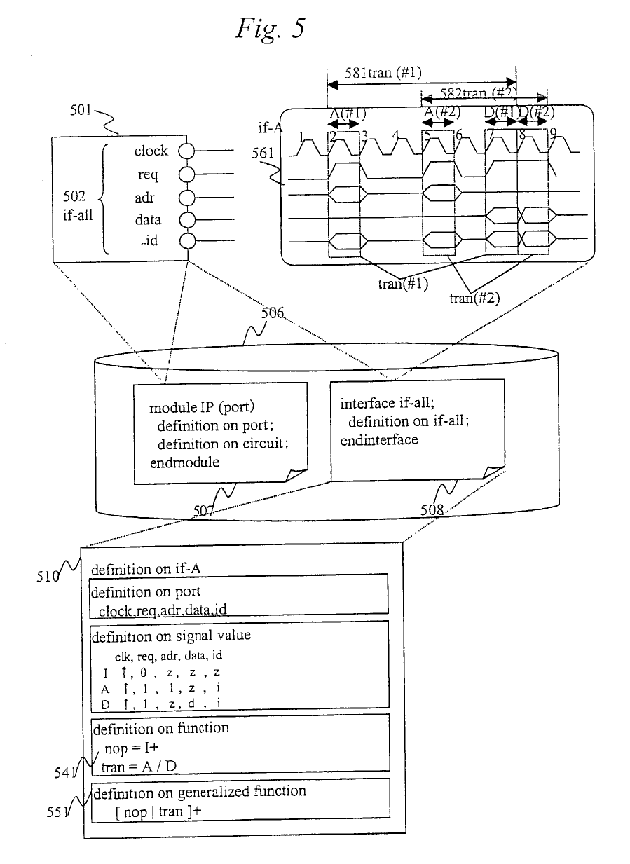

FIG. 5 is a view explaining a circuit module having an interface with split transactions.

A logic circuit 501 includes ports 502. Signal waveforms corresponding to a set of ports 502 are illustrated in an input/output sequence 561.

Similarly to FIG. 3, a circuit description 507 of the logic circuit is stored in a storage medium 506 together with data of definitions on interface 508. The logic circuit 507 includes transaction “tran” for data transfer. This transaction transfers address “adr” and transaction ID “id” at the time of request. At this time, a bus is once released so that other modules can also use the bus. Thereafter, when the preparation of data to be transferred is completed and the bus is in an empty state, a request is repeatedly issued and simultaneously both of the data “data” and the ID “id” having been used at the time of the first request are output. In this manner, the data are transferred. A request for the next transmission or a data transfer may be made in the period between the request and the data transfer.

In the present invention, separable information of the transactions on the same port is stored in the information of definitions on functions 541, so that such an interface can be expressed. In FIG. 5, transaction “tran” is defined by using a code (/) indicating that a next transaction may occur between a sub-transaction A and a sub-transaction D during the temporal interval, similarly to A/D. With this arrangement, it is expressed in a computer interpretable manner that the sending (A(#2)) of the request corresponding to the second tran (tran(#2)), or the sending of a request (A(#2)) and the answering of data (D(#2)) may occur before the data corresponding to the first tran (tran(#1)) is returned (D(#1)).

This can also apply not only to the case illustrated in FIG. 5 in which the same transactions continue but also to the case where different transactions continue. For example, suppose that there are two types of transactions, “write_byte” and “write_word”, each of which comprises write requests (sub-transactions “req_byte” and “req_word”) and responses to the write results (sub-transactions “res_byte” and “res_word”). In this case, the following information is stored in the storage medium 506.

write_byte=req_byte/res_byte;

write_word=req_word/res_word;

In this case, it is interpreted that the sub-transaction of “write_word” may occur between “req_byte” and “res_byte” when sub-transactions are executed in the order of “write_byte” and then “write_word”, and that the sub-transaction of “write_byte” may occur between “req_word” and “res_word” when sub-transactions are executed in the order of “write_word” and then “write_byte”.

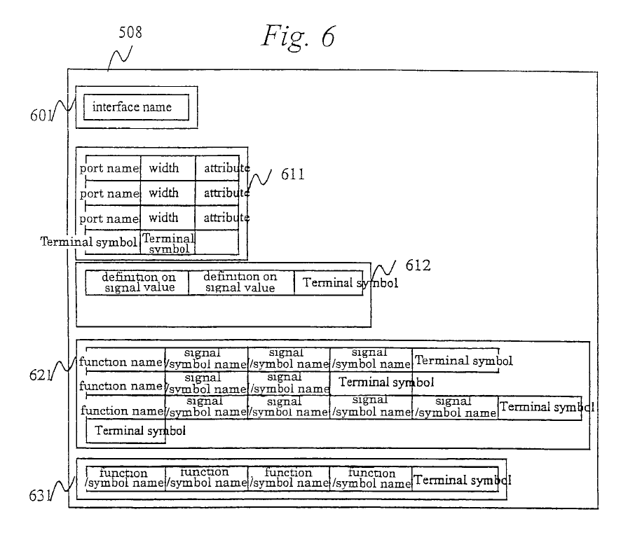

FIG. 6 is a view explaining a data structure in the electronic storage medium of data of definitions on interface 508 stored in a computer-readable storage medium as explained in FIG. 5.

As a point that differs from FIG. 2, in the present embodiment, separable codes indicating that sub-transactions of one transaction can be performed between sub-transactions of another transaction may be stored as code names used in information of definition on functions 621 and information of definition on generalized functions 631, in addition to regular expression codes and parallel behavior codes. By using the storage medium storing therein such information, it is possible to express interfaces having been incapable of being expressed in the conventional methods for expressing module specifications, the methods being based on the conventional state transition machines, and to interpret them on computers.

4. Sub-transactions Occurring in Random Order

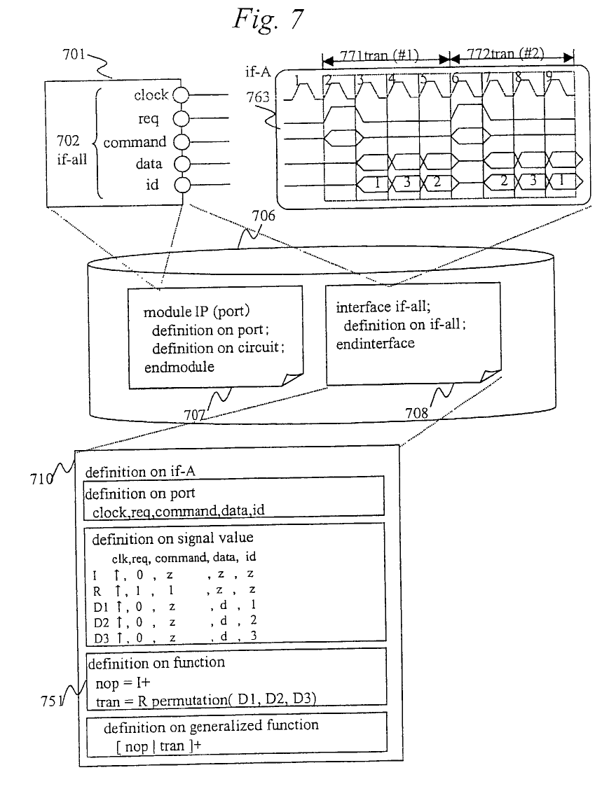

FIG. 7 is a view explaining a circuit module having an interface with sub-transactions that occur in random order.

A logic circuit 701 includes ports 702. Signal waveforms corresponding to a set of ports 702 are illustrated in an input/output sequence 763.

Similarly to FIG. 5, a circuit description 707 of the logic circuit is stored in a storage medium 706 together with data of definitions on interface 708. The logic circuit 701 is connected to a bus to which a plurality of modules is connected. The logic circuit 701 sends a command to the plurality of modules of the bus all at once. All modules that have received the command prepare data in accordance with the contents of the command, and return the respective data to the logic circuit 701. At this time, the order of return is not uniquely determined, but data are sent and returned in the prepared order while avoiding collision of data on the bus. Accordingly, if it is assumed that the number of modules having received the command is n, the number of patterns of the order of return is a factorial of n.

In the present embodiment, by storing information of the possibility of random-order appearance in information of definitions on functions 751, the above-mentioned factorial-of-n patterns can be always expressed with an information amount of a single pattern. For example, when three sub-transactions A, B and C occur in random order, it is to be interpreted that

PERMUTATION (A,B,C)

represents all combinations of order, that is, six patterns of ABC, ACB, BAC, BCA, CAB and CBA.

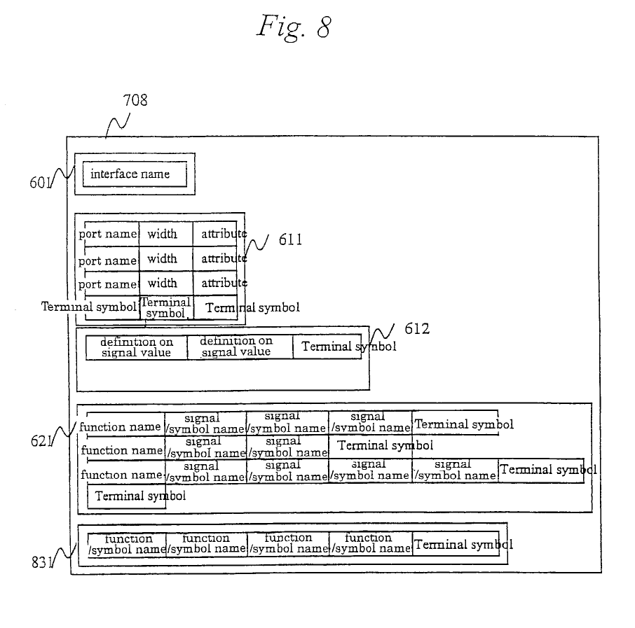

FIG. 8 is a view explaining a data structure in an electronic storage medium of data of definitions on interface 708, which is stored in a computer-readable storage medium as explained in FIG. 7.

As a point that differs from FIG. 2, in the present embodiment, information of possibility of random-order appearance (permutation) can be stored, as code names used in information of definition on functions 621 and information of definition on generalized functions 631, in regular expression codes. By using a storage medium storing therein such information, it is possible to express interfaces having been incapable of being expressed in the conventional methods for expressing module specifications, the methods being based on the conventional state transition machines, and to interpret them on computers.

5. Common Constraints of Transactions

As constraints in performing of the transitions of state machines, the conventional methods for expressing module specifications has been capable of defining constraints in constraint definition units and referring to such constraints in both of function definition units and generalized function definition units. By referring to, in the function definition units, the constraints having been defined in the constraint definition units, the constraints have been made applicable to those functions.

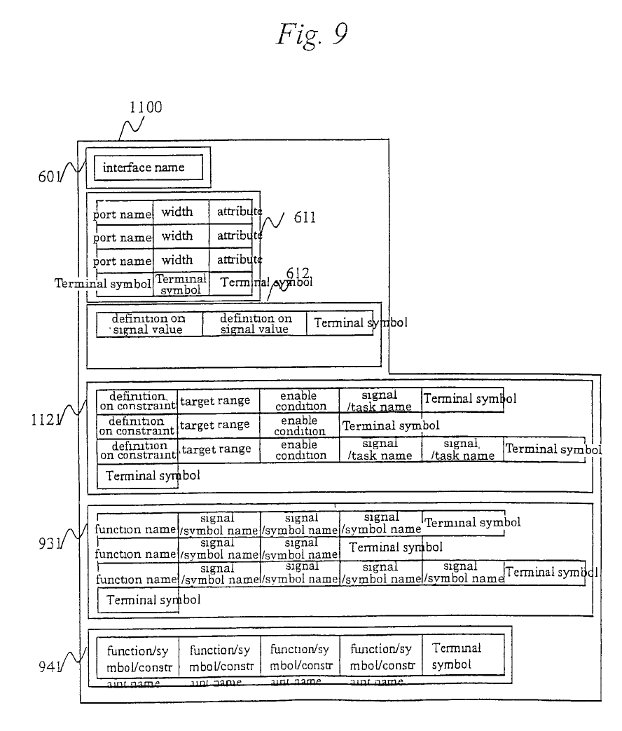

In the present embodiment, information on applications is stored in a constraint definition unit 1121. Constraints are defined through signal value names or variable names (arbitrary variables can be defined when a calculation definition unit is provided) and calculation names. Such calculations include the comparison operations, the four basic operations of arithmetic, and the logical operations. The comparison operations include equality (==), inequality (!=) and comparison of size (<, >, ≦, ≧ etc.). The four basic operations include sum (+), difference (−), product (*) and quotient (/). The logical operations include logical multiplication (&) etc. For example, when there is the constraint that the number of idle cycles should be nine cycles or less, the constraint of constraint “NUMIDLE:(#IDLE<=9)” is defined in the constraint definition unit. In the case where this constraint is applied to transactions, while the conventional methods have referred to the constraint in the respective function definition units, the present embodiment stores information on applications of the constraint in the respective constraints. More particularly, information on whether the constraint is validated for only the function definitions having referred to the above-mentioned constraint or whether it is automatically validated for all the functions including even functions having not been referred to, is stored as an applicable range. In FIG. 9, the method of making the application range corresponding to the unit of each constraint and of recording the constraint is illustrated. However, this may discriminate the constraint per application range to be stored in different portions.

In order to be applicable to further precise of the constraint, it is desirable to store application conditions for constraints as well in addition to the information of the application range. Depending on the constraints, discriminations may be preferably made in that the checking is started after some conditions are formed or in that the checking is performed until some other conditions are met. For example, in the case of constraints having no meanings of the checking during a reset state, it is desirable to apply the constraint on the condition of releasing the reset. Constraint conditions 1190 are stored as additional information for this.

As conditions employed as the constraint conditions, by referring to other constraints, “while the constraint is formed” or “after the constraint has been formed” or “until the constraint is formed” is enumerated. Further, by referring to a certain name of definition on function, “only while the function is being executed” or “after the function has been executed” or “until the function is executed” is enumerated.

While both of application ranges and application conditions are provided in FIG. 9, only application ranges or only application conditions may be provided alternatively.

6. Common Procedures of Transactions

Similarly to the constraints as explained with reference to FIG. 9, the conventional methods for expressing module specifications has used, in a procedure definition unit, substitution or four basic operations, and control structures such as if-sentences or while-sentences or the like to define procedures, and has referred to them in a function definition unit, thereby generating information for using the procedures in the function definition unit.

The present embodiment stores information on applications in a procedure definition unit 1222, thereby reducing information in the function definition unit 931. For example, in the case of counting the number of idle cycles, the procedure of “COUNTIDLE:(NUM_IDLE=NUM_IDLE+1)” is defined in the procedure definition unit. The conventional methods for expression have needed, in the case of executing this procedure for all the transactions, to refer to the above-mentioned procedure at the portions to be counted in all of the function definition units. In contrast, similarly to FIG. 9, the present embodiment has stored effective ranges of procedures in the application ranges and stored conditions applied to such procedures.

The application ranges and the application conditions are the same as the contents explained in connection with FIG. 9. By doing so, idle states can be detected and the number thereof can be counted, without referring to the procedures counted at the respective functions.

7. Definition on Order of Transactions

The conventional methods for expressing module specifications has defined signal changes related to the respective functions of circuit modules in a function definition unit, and defined signal changes in the function definition unit similarly to the case of defining the function even relative to idle states performing no functions. Accordingly, initialization-executing sequences always executed after the reset has been defined similarly to ordinary functions, and, in defining in the generalized function definition unit the appearance order of respective functions arbitrarily executed after the initialization executing sequences, the idle states defined in the function definition unit has been inserted into all the portions having possibility of performing none of functions at this time.

In the conventional information of definitions on generalized functions, signal changes of the initialization-executing sequences, ordinary functions, and signal changes of the idle states are not discriminated from one another, and have been defined as follows.

I+N* SET N* CHK [N|W]+ [R|W|N]+

Thus, an outsider(s) has been unable to understand, on the basis of only this information of definition on generalized functions, which portions the initialization of the sequences is always performed up to and which transactions have meanings among the transactions arbitrarily occurring thereafter and which is in a state executing no transactions, and to be interpreted by tools.

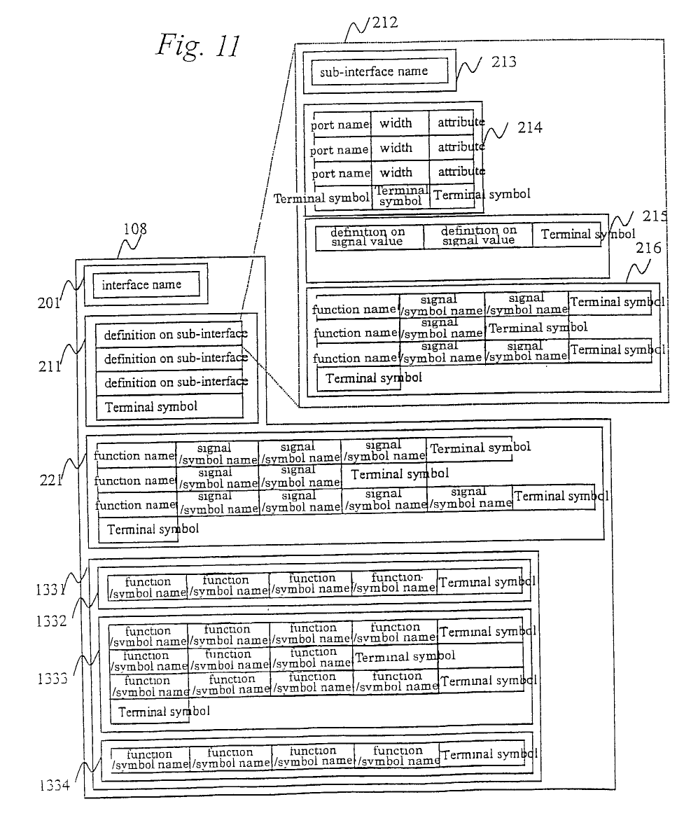

In contrast thereto, the present embodiment separately stores, as illustrated in FIG. 11, an initial execution sequence definition unit 1332, a function definition unit 1333 capable of being executed after the initial execution sequence, and an idle state definition unit 1334. By doing so, without any degradation in description performances of the methods for expressing module specifications, the methods being based on the conventional state transition machines, the initial execution sequences and the functions following thereafter and the idle states can be discriminated through tools. At the same time, the necessity of defining the idle states one by one inserted by the conventional methods is eliminated.

For example, the above-mentioned description example can be expressed as follows.

INITIAL: I+ SET CHK W+

FOREGROUND:

R;

W;

BACKGROUND: N

The term, “INITIAL”, represents signal changes that always occur in starting the circuit as sequences for initialization. The term, “FOREGROUND”, arbitrarily occurs after the initialization and represents meaningful behaviors (transactions). This case means that transaction R or transaction W is performed after signal changes defined as “INITIAL”. The term, “BACKGROUND”, represents idle states having no meaningful behaviors generated at and after the initialization.

As described above, the data structures capable of solving the problems of items 1 to 7, which the conventional methods for expressing module specifications have had, have been explained. It is apparent that some or all of these can be used in combinations. The above-mentioned explanations have been merely made on the basis of examples, and while these are used for defining sub-transactions in some of the above-mentioned examples, they may be also used for defining interfaces and, vice versa, some contents employed for defining interfaces may be used for defining sub-interfaces.

The present invention is now applied to indicate a description example for describing a virtual interface exl. It is noted that the symbol, “//”, denotes remarks for indicating the contents thereof.

interface ex1;// start definition on interface “ex1”

port; // start definition on ports

input.clock clk;

input.control pa1;

output.data pa2;

output.control pb1;

input.data pb2;

input.control pc1;

input.data pc2;

input.control reset en;

endport// termination of definition on ports

state#dif;// start definition on signal value information

signalset a=[clk, pa1, pa2];// definition on sub-interface (set of ports) 1

A0=[R, 0, 0];// “R” represents rising edge on signal clk

A1=[R, 0, 1];

A2=[R, 1, 0];

A#=[R, 1, 1];

endsignalset

signalset b=[clk, pb1, pb2];// definition on sub-interface

(set of ports) 2

B0=[R, 0, 0];

B1=[R, 0, 1];

B2=[R, 1, 0];

B#=[R, 1, 1];

endsignalset

signalset c=[clk, pb1, pb2];// definition on sub-interface

(set of ports) 3

C#=[R, 0, 0];

C1=[R, 0, 1];

C2=[R, 1, 0];

C3=[R, 1, 1];

endsignalset

endstate#dif// termination of definition on signal value information

func#dif;// start definition on functions

a0=A#;

b0=B#;

c0=C#;

a1=A1[1, 4] A2[4];

b1=<B1[1, 2][4][8]>B2;

b2=B3 B1 B2;

c1=[C1+′numofC1#eq#8(#C1)|C2+]C3;

c2=C3 C1 C2;

SHARED: c1#2=c1;// representing that sub-transaction c1 can be shared by a plurality of transactions

Rfunc:// information of definition on related functions

Idle=A0 &/ B0 &/ C0;

w1=par(a1, b1, c1);// representing that sub-transactions a1, b1 and c1 can appear in random order

w2=a1 #/ b1 #/ c1 #2;

w3=a1 #/ b2 #/ (c1/c2); // representing that sub-transactions c1 and c2 are split transactions on the same port

w4=a1 & b1 & c1;

endfunc#dif;// termination of definition on functions

property;/ start definition on constraints executed through references

numofC1#eq#8(int num):(num==8);

enable:(stoi(en)==0);// “stoic” is a function for converting signal value “en” into “int” type

assert#reset: (stoi(reset)==1);

endproperty// termination of definition on constraints executed through references

constraint;//start definition on constraints common to all functions

constraint1// constraint 1 common to all functions

RESET(′assert#reset):// if constraint “assert#reset”

has come true, initialize constraint “constraint1”

ENABLE(′enable):// constraint “constraint1” is effective only when constraint “enable” is true

b2=>c2;// “=>” representing that sub-transaction c2 is always executed after execution of sub-transaction b2 constraint2// constraint 2 common to all functions

WHILE(interval(A0, A3)):// representing that constraint “constraint2” is effective only during detection of A3 after definition on signal value A0

a0 & b0 & c0=> ′false;// representing that “′false” is an inhibited specification and that occurrence of state of “a0 & b0 & c0” is inhibited. Describing such contents as constraints is effective in logical verification of the circuit.

endconstraint// termination of definition on constraints common to all functions

watch;// start definition on procedures common to all functions

c1=>$count#c1;// representing that counting of sub-transaction c1 is always executed if sub-transaction c1 is executed

endwatch// termination of definition on procedures common to all functions

Gfunc#dif;// start of definition on generalized function

FOREGROUND:// information of definition on functions that can be arbitrarily executed after initialization execution sequence

w1;

w2;

w3+w4;

BACKGROUND:// information of definition on idle state idle;

endGfunc#dif;// termination of definition on generalized functions

endinterface// termination of definition on interface ex1

Concerning text descriptions described above, a description method taking over the methods for expressing module specifications, the methods which are based on the conventional state transition machine, has been employed. For improving legibility in the present example, respective identifiers are expressed by “ascii” codes. However, in the case of being stored in the storage medium, these “ascii” codes are stored in binary style. Further, the names used herein are merely for purposes of illustration and are not limited to the illustration.

Moreover, the circulation of circuit modules is performed by circulating the storage medium as illustrated in FIG. 1 and the like. By doing so, when the above-mentioned circuit modules are used to establish system LSIs, verification and the like of interfaces can be easily performed.

### Second Embodiment

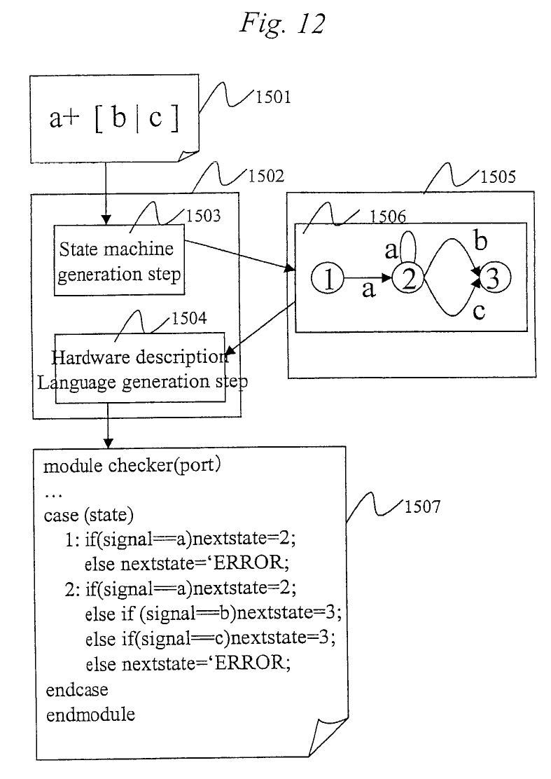

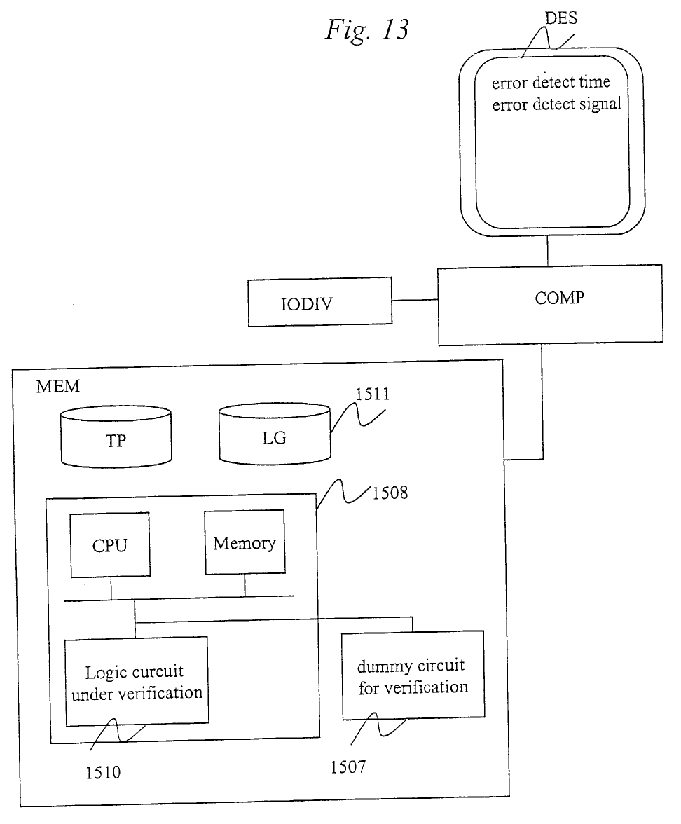

The storage medium of the present invention is utilized for the logical verification of a semiconductor integrated circuit. One example of methods of using it will be illustrated with reference to FIGS. 12 and 13.

FIG. 12 illustrates a flow for generating a pseudo-circuit 1507 for logical verification through a conversion program 1502, from the interface descriptions stored in a storage medium 1501 of the present invention. The program 1502 includes a state machine generating step 1503 and a hardware description language generating step 1504. A state machine 1506 using the storage medium 1501 as an input is generated in a memory 1505 of a computer (not shown) for executing the program 1502. Interface description (a+[b|c]) and the state machine 1506 are equivalent to each other.

The hardware description language generating step 1504 is converted into the pseudo-circuit 1507 written in hardware description language, in order to be capable of executing the state machine 1506 in simulating the logic circuit. The pseudo-circuit 1507 has a state machine similar to the state machine 1506, and, when having detected an input different from that of the state machine 1506, has a function of damping simulation times obtained at that time, names of different signals, detected signal values, or expected values.

FIG. 13 is an example of a structure for executing logic simulations by utilizing the pseudo-circuit formed in FIG. 12. The logic circuit 1508 is a system LSI comprising a logic circuit 1510 to be an object of verification in addition to the logic circuit modules such as the CPU or memory or the like. The verification is performed through a computer system including a computer “COMP”, a memory “MEM”, an input/output device “IODEV” such as a keyboard or the like, and a display “DES”. The logic circuit 1508 described in hardware description language, the pseudo-circuit 1507 for verification formed in FIG. 12, and a test pattern “TP” for making the logic circuit 1508 behave are stored in the memory “MEM”. Further, a memory region “LG” for storing log and the like is stored on the memory “MEM”.

The verification is executed upon making the test pattern “TP” be read by the memory of the logic circuit 1508 (simulation). The pseudo-circuit 1507 for verification monitors the execution of the test pattern TP and monitors whether the logic circuit for objects of verification 1510 is performing behaviors in accordance with specifications. Through this simulation, the pseudo-circuit 1507 can detect logic bugs of the logic circuit for objects of verification 1510 and errors in signals to the logic circuit for objects of verification 1510, and so damp the detected bugs to a log region “LG” or display them on the display “DES” of the computer as a message at the time of the simulation.

By using the storage medium of the present invention, signal changes that could not be described or hardly be described through the conventional methods for expressing module specifications may be described easily.

What is claimed is:

1. A computer-readable storage medium for recording interface information of a circuit module having a first set of ports and a second set of ports, the storage medium comprising:
a first identifier region for storing, as a first set of identifiers, combination patterns of signal values that respective ports of said first set of ports are capable of assuming at a specific time;
a second identifier region for storing, as a second set of identifiers, combination patterns of signal values that respective ports of said second set of ports are capable of assuming at a specific time; and
a third identifier region for storing, as a third set of identifiers, functions of said circuit module defined as combinations of specified first identifiers stored in said first identifier region and specified second identifiers stored in said second identifier region,
wherein said third identifiers include said specified first identifiers and said specified second identifiers.

2. The storage medium according to claim 1,
wherein said third identifiers further include a string of codes for indicating that starting orders of combination patterns corresponding to said specified first identifiers and of combination patterns corresponding to said specified second identifiers are undefined.

3. The storage medium according to claim 2, further comprising a region for storing “HDL” data described with behaviors or structures of said circuit module.

4. The storage medium according to claim 1,
wherein said third identifiers further include a string of codes for indicating that the combination patterns corresponding to said specified second identifiers occur once according as the combination patterns corresponding to said specific first identifiers occur twice or more.

5. The storage medium according to claim 4, p1 wherein the combination patterns corresponding to said specified first identifiers occur twice or more according as the same transactions occur twice or more.

6. The storage medium according to claim 4,
wherein the combination patterns corresponding to said specified first identifiers occur twice or more according as different transactions occur twice or more.

7. A computer-readable storage medium for recording interface information of circuit module having a set of ports, the storage medium comprising:
a first identifier region for storing, as a set of identifiers, combination patterns of signal values that respective ports of said set of ports are capable of assuming at a specific time; and
a second identifier region for storing, as a second set of identifiers, functions of said circuit modules defined as combinations which includes first identifiers stored in said first identifier region,
wherein said second identifiers includes said first identifiers.

8. The storage medium according to claim 7,
wherein said second identifier region is constituted to store, as a second set of identifiers, functions of said circuit module defined as combinations of first identifiers (A) stored in said first identifier region and of first identifiers (B) stored in said first identifier region, and
wherein said second identifiers include a string of codes indicating that said first identifiers (A) and respective combination patterns corresponding to said first identifiers (B) and said first identifiers (A), and said first identifiers (B) occur at a temporal interval, and that combination patterns corresponding to other identifiers stored in said first identifier region are capable of occurring meantime.

9. The storage medium according to claim 7,
wherein said second identifier region is constituted to store, as a second set of identifiers, functions of said circuit module defined as combinations of a plurality of first identifiers stored in said first identifier region, and
wherein said second identifiers include a string of codes indicating that said plurality of first identifiers and a plurality of combination patterns corresponding to said plurality of first identifiers are capable of occurring in arbitrary order.

10. The storage medium according to claim 7,
wherein said storage medium further includes a constraint definition region for defining constraints,
wherein said second identifier region is constituted to store, as a second set of identifiers, functions of said circuit module defined on the basis of specified first identifiers stored in said first identifier region and specified constraints stored in said constraint definition region, and
wherein said constraints include a first constraint and a second constraint, said first constraint being validated through reference by said second identifiers and said second constraint being validated without reference by said second identifiers.

11. The storage medium according to claim 10,
wherein said constraints are defined as logic operations.

12. The storage medium according to claim 10,
wherein said constraints include a third constraint, and said third constraint is validated when a specific application condition thereof is satisfied.

13. The storage medium according claim 7,
wherein said storage medium further includes a procedure definition region for defining procedures,
wherein said second identifier region is constituted to store, as a second set of identifiers, functions of said circuit module defined on the basis of specified first identifiers stored in said first identifier region and specified procedures stored in said constraint definition region, and
wherein said procedures include a first procedure and a second procedure, said first procedure being validated through reference by said second identifiers and said second procedure being validated without reference by said second identifiers.

14. The storage medium according to claim 13,
wherein said procedures are defined as operations.

15. The storage medium according to claim 13,
wherein said procedures include a third procedure, and said third procedure is validated when a specified application condition thereof is satisfied.

16. A computer-readable storage medium for recording interface information of a circuit module having a set of ports, the storage medium comprising:
a first identifier region for storing, as a set of identifiers, combination patterns of signal values that the respective ports of said set of ports are capable of assuming at a specific time;
a second identifier region for storing, as a second set of identifiers, functions of said circuit module defined by using first identifiers stored in said first identifier region; and
a third identifier region for storing, as a third set of identifiers, appearance order of functions of said circuit module defined by using a plurality of second identifiers stored in the second identifier region,
wherein said third identifier region includes a first region and a second region, said first region storing therein second identifiers for defining functions of said circuit module that appears in a stationary state and said second region storing therein second identifiers for defining that said circuit module is in a non-behaving state.

17. The storage medium according to claim 16,
wherein said set of third identifiers include a third region, and said third region stores therein second identifiers for defining functions of said circuit module that is executed during a period from start of initialization to said stationary state.

18. The storage medium according to claim 17,
wherein said initialization is started when said circuit module is connected to a power supply or when reset occurs.
